(19) United States
(12) Patent Application Publication
(10) Pub. No.: US 2009/0019994 A1
(43) Pub. Date: Jan. 22, 2009

(54) METHOD AND SYSTEM FOR DETERMINING A MEASURE OF TEMPO AMBIGUITY FOR A MUSIC INPUT SIGNAL

(75) Inventor: Martin Franciscus McKinney, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,219

(22) PCT Filed: Jan. 18, 2005
(86) PCT No.: PCT/IB05/50212

§ 371 Date: Jul. 17, 2006

(30) Foreign Application Priority Data
Jan. 21, 2004 (EP) 04100175.1

(51) Int. Cl. G10H 1/40

(52) U.S. Cl. 84/612

(57) ABSTRACT

The invention describes a method for determining a measure of tempo ambiguity for a music input signal (1). The method comprises identifying candidate tempos (2) of the music input signal (1); ranking the candidate tempos (2) according to their relative strengths; and compiling a tempo scheme (4) comprising the relationship of the ranked candidate tempos (2′) to each other. Moreover the invention describes an appropriate system (7) for determining a measure of tempo ambiguity for a music input signal (1).

This invention relates in general to a system and method for determining a measure of tempo ambiguity for a music input signal, and to an audio processing device for choosing a piece of music according to a tempo scheme.

The tempo or beat of a piece of music is a perceptual concept that a human feels in music. It is known that humans do not always perceive a piece of music to have a single tempo. Depending on the temporal recurrence structure of the piece of music, some listeners might for example dance or tap to the fastest beat, while others are more comfortable dancing or tapping to a slower beat. It has been shown that, when asked to tap along to a piece of music, listeners tap at different rates. The tapping rates are generally related by integer scalars with the scalar value dependent on the meter of the music. For a piece of music with a considerably fast pulse, e.g. 180 bpm, some listeners might tap at half the pulse-rate. On the other hand, for a relatively slow piece of music, some listeners might prefer to tap at double the pulse rate. In addition, for certain pieces of music, there is more agreement across listeners as to the tapping rates, i.e. less ambiguity in tempo perception, than for other pieces of music.

The tempo ambiguity for a particular piece of music can be regarded as a measure of the likelihood of a listener's perceiving a particular tempo or pulse. Depending on which piece of music, several tempos might be perceived in differing proportions, or practically all listeners might agree on one tempo or pulse. This tendency among listeners to perceive a variety of tempos when listening to a piece of music is a result of human personality and temperament, and is unrelated to tempo tracking errors, which might occur in the case of a listener with little or no sense of rhythm. In the following, the expressions “tempo”, “pulse”, “beats per minute” and its abbreviation “bpm” all have the same meaning.

When music serves a particular function, for example when it supplies the beat or rate at which a person is to train on a jogging, cycling or rowing apparatus in a fitness studio or physiotherapy practice, ambiguity in tempo perception can be a problem. For example, a person who generally moves to the faster tempo might also jog or cycle too fast for his training or therapy program. On the other hand, a person who generally picks out the slower tempo might move to the slower pulse and, as a result fail to achieve his training goals.

A strong discrepancy in tempo between two pieces of music can have an uncomfortably jarring effect when cross-fading or overlaying the pieces. A human DJ well acquainted with the music collection might choose pieces of music for playing one after the other based on his experience, requiring an in-depth knowledge of the music collection. A human DJ might know that even though a particular piece of music has a fast beat, it also has a perceptible slower beat which allows it to be preceded or followed by a different piece with a corresponding slow tempo. However, if the music selection is effected by a computer, as is increasingly the case for many radio stations, the resulting jarring tempo discrepancy can be quite uncomfortable to listen to.

Various methods are available for deriving musical tempo from a music input signal, such as resonant filter-bank methods, multiple agent methods and probabilistic methods. Current methods provide only a single value for bpm, often inaccurate, and sometimes even requiring user intervention. They fail to accurately represent the perceived ambiguity that exists in the perception of tempo. It is this underlying ambiguity in tempo perception that makes it difficult, if not impossible, to express the tempo for a piece of music as a single value.

Therefore, an object of the present invention is to provide a system and a method which can be used to easily provide a measure of tempo ambiguity for a music input signal without requiring user intervention.

To this end, the present invention provides a method for determining a measure of tempo ambiguity for a music input signal wherein the system comprises identifying candidate tempos in the music input signal, ranking the candidate tempos according to their relative strengths, and compiling a tempo scheme comprising the relationship of the ranked candidate tempos to each other.

Even though the time-signature for a piece of music might indicate that it has a particular pulse, e.g. 3 beats per bar, other slower or faster tempos might be perceived by listeners when listening to the piece of music, depending on the genre of the piece, the type of instruments, how they are played, the mood of the listener and a number of other factors. One listener might detect a faster tempo at half-note or quarter-note level, while another listener might equally well perceive a slower tempo. These tempos along with any further tempos perceived by other listeners are “candidate tempos” for the piece of music.

The “music input signal” is a signal which might originate from a music data file, an MP3 music file, etc. The music input signal can also be an analog signal, e.g. from a microphone, which is preferably—but not necessarily—converted into digital form for further digital signal processing. The music input signal might be a complete rendering of a song from start to finish, or it might be an excerpt. For the sake of simplicity, any reference to “music input signal” or “music output signal” in the following text is assumed to refer also to “piece of music”, or vice versa.

An appropriate system for determining a measure of tempo ambiguity for a music input signal comprises a tempo identifying unit for identifying candidate tempos in the music input signal, a ranking unit for ranking the candidate tempos according to their relative strengths, and a tempo scheme compiler to compile a tempo scheme comprising the relationship of the ranked candidate tempos to each other.

The method and the system thus provide an easy way of automatically determining a measure of the tempo ambiguity of a piece of music compiled in a tempo scheme, thus allowing a user to select and use pieces of music according to tempo scheme.

The dependent claims and the subsequent description disclose particularly advantageous embodiments and features of the invention.

The candidate tempos can essentially be ranked in a number of ways. Preferably however, a dominant tempo is identified from among the candidate tempos, and any remaining candidate tempos are identified as subordinate tempos. The candidate tempos can then be ranked in an order progressing from dominant to subordinate. When listening to a particular piece of music, it may be that the majority of listeners tend to perceive one particular tempo, whereas the minority might tend to perceive a different tempo. In this case, the tempo perceived by the majority of listeners would be accorded a higher ranking than the tempo perceived by the minority. The relationship between the higher and the lower ranking is a measure of the tempo ambiguity for this piece of music. The higher-ranking tempo candidate can be described as the “dominant tempo”, while the lower-ranking tempo is “subordinate”. Equally, it may be that for a particular piece of music, one particular tempo is perceived by almost all listeners and only a negligible number of listeners perceives a different tempo. In this case there is only one candidate tempo for the piece of music, i.e. one dominant tempo, and no ambiguity. On the other hand, listeners to another piece of music might perceive several different tempos, one or more of which might dominate, while the remainder are subordinate. Three, four or even more tempos might be perceived by listeners and can all be ranked according to their likelihood of being perceived. It might be that a number of tempos are perceived more or less equally strongly, so that the perceived tempos are accorded equal ranking. The “official” tempo assigned to a piece of music might not necessarily be the dominant perceived tempo, and might therefore be accorded a lower ranking.

In this embodiment of the invention, the tempo ambiguity is therefore a measure of the relative strengths or likelihoods of any dominant tempo to any subordinate tempos. The ambiguity measure may be the ratio between the likelihoods of the dominant and the subordinate tempo candidates of being perceived. More specifically, it could be calculated as L2/L1, where L1 is the likelihood (ranging from 0.0 to 1.0) of the most dominant tempo and L2 is the likelihood of the second most dominant tempo. In this way, the tempo ambiguity measure is normalized to fall between 0.0 and 1.0. In the simplest case, a piece of music features one dominant tempo, and no subordinate tempos are detected. In this case, the single tempo has a likelihood of 1.0 and is therefore assigned an ambiguity value of 0.0. In another simple case of two tempos being detected, each with roughly equal strength, the tempos are each equally likely to be perceived by a listener, so that their likelihood values are equal. Therefore the ambiguity measure is 1.0. If more than two tempos are likely to be perceived, the overall tempo ambiguity can be calculated as above but using only the two most dominant tempo candidates. The ranked tempo values, their measures of likelihood and the overall tempo ambiguity can be compiled in a tempo ambiguity scheme, which might be such that the bpm values of the detected tempos are listed in order of decreasing rank or strength, followed by the likelihood values for each of the subordinate tempos and finally the overall tempo ambiguity.

In one embodiment of the invention, the tempo ambiguity scheme is assigned to the music signal for which it was compiled, for example in a list containing pointers or references. The list might contain a pointer to a piece of music, indicating from which database it can be retrieved, and another pointer to its associated tempo scheme, and might be searchable by music title, by tempo, by ambiguity measure, etc. The music database might be in storage device separate from the list of tempo schemes, or they may be stored on the same device e.g. on a personal computer, on a CD or DVD etc. The music database might be stored in one location or might be distributed over several devices, e.g. a collection of music CDs.

In a preferred embodiment of the invention, the tempo scheme is inserted directly into the music data file containing the music input signal, e.g. into the proprietary part of the ID tag of the header of an MP3 music file, so that the tempo scheme and the information it represents can simply be read from the music data file, and no extra effort is required to first locate and retrieve it from a separate database.

In one embodiment of the present invention the candidate tempos are identified from the outputs of a series of resonator filter-banks that are driven by a pre-processed version of the music signal. Such a system has been shown to resemble many aspects of human perception of tempo.

Therefore, in a preferred embodiment of the invention, the tempo identifying unit comprises an array of band-pass filters for splitting the music input signal into different frequency bands. Each of these frequency bands can in turn be passed to a plurality of resonator filter banks.

In a particularly preferred embodiment of the invention, each array or bank of resonators comprises the same configuration of resonator filters, so that each frequency band can be processed in the same way. A resonator filter will identify a musical pulse or tempo corresponding to its resonant frequency. Each resonator filter in a resonator filter array might correspond to a candidate tempo of interest e.g. 60 bpm, 80 bpm, 120 bpm etc. A particularly advantageous embodiment of the invention contains a sufficiently large number of resonators in its resonator banks to cover all common bpm values. Alternatively, the filters might be realized in such a way that they can be tuned to particular tempos of interest.

The energy output of each resonator filter can subsequently be calculated over time in a resonator energy calculator.

The outputs of the resonators with like frequencies, e.g. the outputs of all resonators tuned to 120 bpm, can then be summed together in an energy summation unit to give a total energy value for each tempo candidate. In a preferred embodiment of the invention, the system comprises a ranking unit to compare the sum total energy values for the candidate tempos and rank them in order of their relative energy strengths because it has been shown that, with appropriate processing of the music input signal and resonator filter-bank construction/configuration, tempos with higher energy values are more likely to be perceived by listeners to be dominant. The tempo scheme compiler can then examine the relative strength values and compile a tempo scheme for the piece of music based on these values.

A further preferred embodiment of the invention allows the user to control the manner in which the tempo scheme is determined and the manner in which the tempo scheme is to be associated with the piece of music for which it has been generated. To this end, the user can preferably specify, for example, a threshold level over which the output must be in order for the frequency of a resonator to be considered a tempo candidate. Also, the user might wish to specify the parameters for relationship between different tempo candidates, for example the maximum allowable magnitude difference between dominant and subordinate tempo candidates. Further, the user might specify the manner in which the tempo scheme is to be encoded, and whether the tempo scheme is to be included in a music output file or stored in a separate location. Therefore, the system preferably comprises a suitable interface for user interaction.

The tempo scheme can be used to classify a piece of music according to its tempo(s). The relationship is described between the different tempos of a piece of music. Using the information supplied in the tempo scheme, pieces of music can be located with a particular tempo, one single dominant tempo, or a plurality of tempos. Thus, a piece of music can be selected from a music database on the basis of its tempo scheme, while other unsuitable pieces are rejected.

Preferably, the tempo scheme generated according to the invention will be used by an appropriate audio processing device that chooses a piece of music from a selection of titles in a database according to a particular tempo scheme. The audio processing device might be a stand-alone device, for example in a recording studio, or might be incorporated as part of another device, for example a personal computer or a home entertainment device. Here, an “audio processing device” is a device that can process, select, store, retrieve, and input and/or output audio signals or audio data.

The system for generating a tempo scheme as described above might be incorporated in the audio processing device. Alternatively, the piece of music and its associated tempo scheme may be stored on a memory device according to the invention. Such a memory device might be for example a CD, a hard-disk, a DVD, a memory stick etc. The tempo scheme might be incorporated in the music data file or might be stored in a separate sector or block of memory. In this case, the audio processing device need not comprise the system for generating a tempo scheme. It suffices that the device can retrieve a tempo scheme from memory and assign it to the associated piece of music.

In a preferred embodiment of the audio processing device, a music query system can search a music database to locate a piece of music with a particular tempo scheme. The user might request a piece of music with a particular dominant tempo, a tempo ambiguity measure, and subordinate tempos with certain likelihood values. The music query system might then search one or more music databases to locate a suitable piece of music. The user might further specify the genre of the piece, e.g. if it is to be a jazz piece or hip-hop. The range of tempo ambiguity value might also be specified to lie within a specific range. By specifying tempo parameters in this way, the user can use the music query system to locate pieces of music with high levels of tempo ambiguity, or pieces of music with a single clear tempo and no tempo ambiguity whatsoever, depending on the user's requirements.

In a preferred embodiment, the audio processing device may be incorporated in an exercise apparatus such as a home trainer or a training apparatus used in a fitness studio or in a physiotherapy practice. The audio processing device can select pieces of music from a music database according to tempo scheme to suit the training schedule of the user. The electronic device is ideally configurable to the user's particular requirements. If the user generally tends to move to the faster tempo of a piece of music featuring more than one candidate tempos, thus resulting in an overly fast pace with possible detrimental effects, the device can specifically select pieces of music with a tempo which matches the desired pace of training, and no ambiguity. Alternatively, the device can select pieces of music with a dominant tempo slower than the pace of training, but featuring a faster subordinate tempo to suit the pace of training, since the user will tend to pace himself at the faster tempo.

In another preferred embodiment, the audio processing device may be incorporated in a portable training device, for example a portable jogging aid. The user might specify training goals, for example maximum heart rate, and might preload the audio processing device with preferred music files, for example in the form of MP3 files, to accompany the training. Equally, the device might feature an appropriate interface for reading music data files from a memory stick or smart card. The audio processing device might be connected to or incorporated in a mobile phone, so that music files can be downloaded from the Internet as required. The user might specify preferred tempo ambiguities and tempo schemes for the music selection, e.g. he might prefer music with a fast tempo and an underlying slower tempo. The audio processing device might feature a means of determining the user's jogging rate, and might adapt the choice of music accordingly.

In a particularly preferred embodiment, the audio processing device might be connected to a heart rate monitor, so that the user's heart rate can be determined and the music selection be adapted as required. For example, if the user jogs to the faster tempo of a piece of music, and his heart rate exceeds a predefined value, the audio processing device might select a more suitable piece with a slower tempo and fade this piece in.

Another embodiment of the audio processing device comprises an automatic DJ apparatus for selecting pieces of music from a music database according to a desired sequence. Such an automatic DJ apparatus might be a professional device in a recording studio, in a radio or TV station, in a discotheque, etc, or might be incorporated in a PC, a home entertainment device, a PDA, a mobile phone etc. The automatic DJ apparatus might comprise an audio output for playing the selected pieces of music, or it might be connected to a separate means of playing music. It might feature a means of connecting to a remote music database, e.g. in the Internet, or to a local music database, e.g. a list of MP3 files on a home entertainment device. The user might specify a desired sequence of music types, e.g. a first set of songs is to be rock-and-roll, the next set is hip-hop, the following set is dance, and this set is in turn followed by a slow set. The automatic DJ apparatus searches a music database for tempo schemes and genres to suit the specified sequence and compiles a list of the pieces of music in the desired order. With the exception of the last piece of music, each piece of music is followed by another. A first song is faded out while a second is faded in. The automatic DJ apparatus selects songs on the basis of their tempo schemes so that only a minimal amount of tempo discrepancy between the pieces can be detected, with the result that the cross-fading or transition between two songs is pleasing to the ear. For example, a sequence of songs might be so chosen that the first song has a dominant tempo of 180 bpm, the second song features two tempos—90 bpm and 180 bpm—with a high measure of tempo ambiguity, and the third song has a dominant tempo of 90 bpm. The first and third songs might feature further subordinate tempos which have low values of ambiguity. When played one after the other, the tempo segues from 180 to 90 unnoticeably.

The system according to the invention can preferably be realized as a computer program. All components for determining a measure of ambiguity for a music input signal such as filter-banks, resonator filter-banks, energy summation unit, ranking unit, tempo scheme compiler etc. can be realized in the form of computer program modules. Any required software or algorithms might be encoded on a processor of a hardware device, or be encoded on a separate processor, so that an existing hardware device might be adapted to benefit from the features of the invention. Alternatively, the components for determining a measure of ambiguity for a music input signal can equally be realized using hardware modules, so that the invention can be applied to digital and/or analog music input signals.

Other objects and features of the present invention will become apparent from the following detailed descriptions considered in conjunction with the accompanying drawing. It is to be understood, however, that the drawing is designed solely for the purposes of illustration and not as a definition of the limits of the invention.

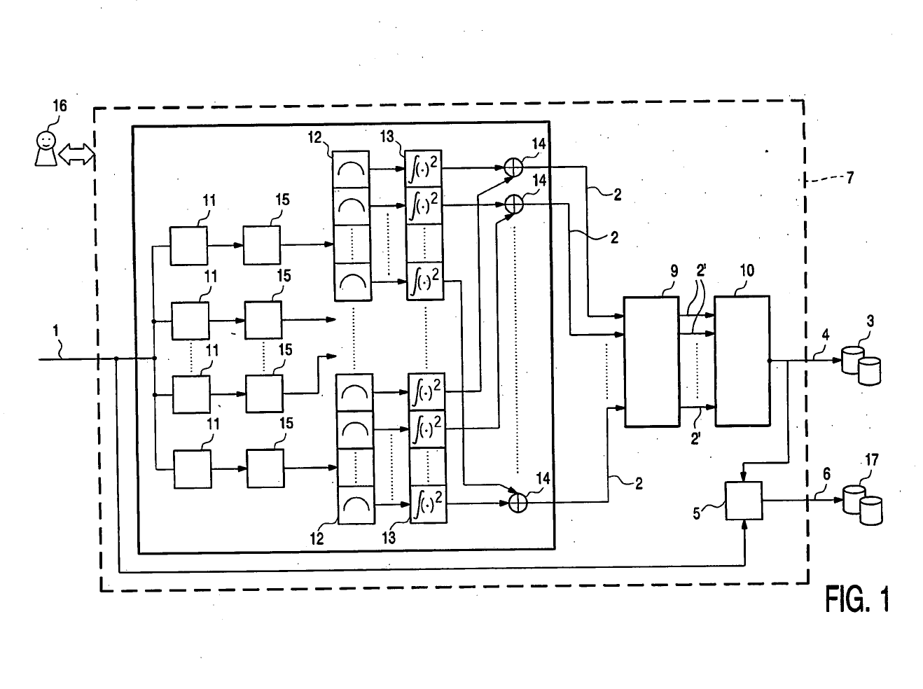

FIG. 1 is a schematic block diagram of a system for determining a measure of tempo ambiguity for a piece of music in accordance with an embodiment of the present invention.

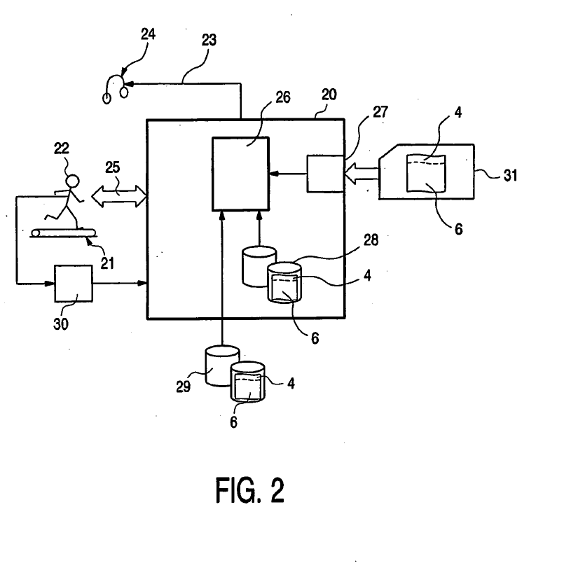

FIG. 2 is a schematic block diagram of a training apparatus for selecting pieces of music on the basis of tempo scheme in accordance with an embodiment of the present invention.

In the description of the following figures, it is understood that the system includes a means of interpreting commands issued by the user in the usual manner of a user interface.

FIG. 1 shows a system 7 for calculating a tempo scheme 4 for a music input signal 1 in which the music input signal 1 is first split into four broad frequency regions by means of four band-pass filters 11. Here, the music input signal 1 is split into four frequency bands representing its high-, mid-high-, mid-low and low-frequency components. These frequency bands are each fed to a half-wave rectifier unit 15 where they undergo a first processing by being high-pass filtered, differentiated and half-wave rectified in preparation for further processing. The high-pass filtering accentuates sharp transitions in the signal which are typically associated with event onsets that are important for tempo and rhythm perception.

The outputs of the half-wave rectifiers 15 are then each passed to a resonator filter-bank 12. Each resonator filter-bank 12 comprises an identical set of resonator filters. The resonant frequencies can be tuned to a tempo range of interest using predefined values or a set of values selected by a user 16 from a pre-defined range of values. The energy output for each resonator is calculated over time in a corresponding energy summation unit 13 by integrating the output signal of the resonator over a given period. The summed energy output for each resonator or candidate tempo is passed to a summation unit 14, where the outputs of the resonators with like frequencies are summed together to give a total value 2 over all the frequency bands for each candidate tempo.

The total energy values 2 are then compared in a ranking unit 9. The ranking unit 9 sorts the candidate tempos according to their relative energy strengths into a list of ranked tempo candidates 2′. Only values higher than a pre-defined threshold level are taken into consideration. The threshold level can be a pre-defined value, or can be modified by the user 16. Higher values are identified as dominant tempos, while lower values are identified as subordinate tempos.

The relationship between the ranked tempos 2′ is calculated by the tempo scheme compiler 10 to give the tempo scheme 4 for this piece of music. The measure of ambiguity is normalized to fall between 0.0 and 1.0, where a value of 0.0 indicates an absence of tempo ambiguity, whereas a value of 1.0 would indicate two or more equally strong tempo candidates. The tempo scheme 4 consists of one or more dominant tempos followed by any subordinate tempos and the ambiguity measure.

The tempo scheme 4 can be output separately to a database 3, or can be combined with the music input signal 1 in a manner specified by the user 16, for example by writing the tempo scheme 4 into the proprietary ID tag of an MP3 music file header by means of an editor 5, and storing the music file 6 to a memory device and/or database 17.

FIG. 2 shows an audio processing device 20 connected to or incorporated in a known device 21 such as a home trainer, a rowing machine, a cycling machine etc. The audio processing device 20 selects pieces of music on the basis of tempo scheme to assist the training program of a user 22. By means of a user interface 25, the user 22 can specify a workout regimen, in terms of tempo and tempo changes and/or in terms of desired heart rate and heart rate changes. A workout controller 26 monitors the user's workout progress.

The music to accompany the workout is chosen from one or more sources. A card reader 27 for an SD card or MMS card 31 allows the user to supply his own personal collection of preferred music. Alternatively, the audio processing device 20 can select music from an internal music database 28, for example a collection of MP3 Music files, or from an external database 29, for example by locating and downloading pieces of music from the internet. The music files 6 which are stored on the card 31 or in the databases 28, 29 comprise music data and a tempo scheme 4. If no song can be found with the specified tempo, the workout controller 26 can speed it up or slow it down slightly until it matches the desired tempo. The selected music 23 is output via a music output device 24, in this case a set of headphones.

A pulse monitor or step counter 30 provides feedback about the user's training progress. The workout controller 26 can determine, on the basis of this feedback and the predetermined workout regimen, whether the user 22 is moving too fast or not fast enough. The music selection is adjusted accordingly, either by selecting a more suitable piece of music from one of the sources (26, 27, 28) according to the tempo schemes 4 in the music files 6 and outputting this, or by adjusting the music speed in order to encourage the jogger to speed up or slow down as appropriate, and consequently increasing or decreasing his heart rate accordingly.

Although the present invention has been disclosed in the form of preferred embodiments and variations thereon, it will be understood that numerous additional modifications and variations could be made thereto without departing from the scope of the invention. For example, a generally known method other than the one described could be used for deriving musical tempo from a music input signal, such as a multiple agent method or a probabilistic method.

For the sake of clarity, it is also to be understood that the use of “a” or “an” throughout this application does not exclude a plurality, and “comprising” does not exclude other steps or elements. A “unit” may comprise a number of blocks or devices, unless explicitly described as a single entity.

1. A method for determining a measure of tempo ambiguity for a music input signal (1), which method comprises:
identifying candidate tempos (2) of the music input signal (1);
ranking the candidate tempos (2) according to their relative strengths;
compiling a tempo scheme (4) comprising the relationship of the ranked candidate tempos (2′) to each other.

2. A method according to claim 1 wherein a dominant tempo and any subordinate tempos are identified among the candidate tempos (2).

3. A method according to claim 1, wherein the tempo ambiguity scheme (4) is assigned to the music input signal (1).

4. A method according to claim 3, wherein the tempo ambiguity scheme (4) is combined with the music input signal (1) in a music file (6).

5. A system (7) for determining a measure of tempo ambiguity for a music input signal (1), said system comprising:
a tempo identifying unit (8) for identifying candidate tempos (2) in the music input signal (1);
a ranking unit (9) for ranking the candidate tempos (2) according to their relative strengths; and
a tempo scheme compiler (10) to compile a tempo scheme (4) comprising the relationship of the ranked candidate tempos (2′) to each other.

6. The system of claim 5, wherein the tempo identifying unit (8) comprises a plurality of band-pass filters (11) for splitting a music input signal into different frequency bands, a plurality of resonator filter-banks (12) for identifying candidate tempos in each of the frequency bands, a plurality of resonator energy calculators (13) for calculating an energy value for each resonator filter of the resonator filter-banks (12) and a plurality of energy summation units (14) for summing the calculated energy values for like resonators of the different frequency bands.

7. An audio processing device for choosing a piece of music according to a particular tempo scheme generated by a method according to claim 1.

8. An audio processing device according to claim 7 comprising:
a tempo identifying unit (8) for identifying candidate tempos (2) in the music input signal (1);
a ranking unit (9) for ranking the candidate tempos (2) according to their relative strengths; and
a tempo scheme compiler (10) to compile a tempo scheme (4) comprising the relationship of the ranked candidate tempos (2′) to each other.

9. An audio processing device according to claim 7 comprising a music query system for choosing a music data file from a database on the basis of a particular tempo scheme.

10. An audio processing device according to claim 7 comprising an automatic DJ apparatus for choosing pieces of music from a music database according to a user-defined tempo scheme so that cross-fading with minimal tempo discrepancy between subsequent pieces of music is achieved.

11. Exercise apparatus or training device comprising an audio processing device according to claim 7 for selecting on the basis of tempo scheme a piece of music to suit a user's requirements for exercising at a desired tempo.

12. A computer program product directly loadable into the memory of a programmable audio processing device comprising software code portions for performing the steps of a method according to claim 1 when said product is run on the audio processing device.

13. A method according to claim 4, wherein the music file and its associated tempo ambiguity scheme are stored in a memory medium.
